(19) United States
(12) Patent Application Publication
(10) Pub. No.: US 2008/0284071 A1
(43) Pub. Date: Nov. 20, 2008

(54) Package of Flat Packed Pocketed Spring Core Assemblies

(75) Inventors: Kelly M. Knewtson, Joplin, MO (US); William B. York, III, Carthage, MO (US)

Correspondence Address: WOOD, HERRON & EVANS, LLP, 2700 CAREW TOWER, 441 VINE STREET, CINCINNATI, OH, 45202, US

(73) Assignee: L&P PROPERTY MANAGEMENT COMPANY, South Gate, CA (US)

(21) Appl. No.: 12/184,651

(22) Filed: Aug. 1, 2008

Related U.S. Application Data
(62) Division of application No. 11/697,032, filed on Apr. 5, 2007.

(51) Int. Cl. F16F 3/04

(52) U.S. Cl. 267/91

(57) ABSTRACT

Package (10) of flat-packing multiple pocketed spring core assemblies (12) wherein a stack of multiple pocketed spring assemblies (12) are trapped between a pair of wooden frames (16). After compression of the stack including the wooden frames (16), bands (28) are tightly wrapped around the compressed stack. Loops of wire (32) are then inserted through the stack and wrapped about at least one cross element (34) of the frame (16) on each side of the stack. Each loop of wire (32) is pulled taut and its opposite ends connected together so as to prevent the center portion of the stack from ballooning outwardly after removal of compression forces on the rigid frames.

### CROSS REFERENCE TO RELATED APPLICATIONS

This application is a divisional of U.S. patent application Ser. No. 11/697,032 filed Apr. 5, 2007 entitled “Flat Pack Mattress Spring Core Assemblies and Method of Packaging Such Assemblies”, which is fully incorporated herein.

### FIELD OF THE INVENTION

This invention relates to the packing for shipment of pocketed spring core assemblies, which assemblies are to be subsequently used by a mattress manufacturer to manufacture upholstered mattresses.

### BACKGROUND OF THE INVENTION

Spring cores for mattresses comprise an array of mattress springs arranged in interconnected rows and columns. In many cases, such spring cores are pocketed spring core assemblies, meaning that the individual springs of the array are all enclosed within individual fabric pockets. Such pocketed spring assemblies have traditionally been rolled up and inserted into a bag as disclosed, for example, in U.S. Pat. No. 7,059,101 before being shipped to a mattress manufacture.

One drawback to this method of shipment is that border wires must be shipped separately from the rolled up pocketed spring assemblies and applied to the spring assemblies at the location of the mattress manufacturer. In addition to the relatively high shipping costs associated with this shipping method, the mattress manufacture must have enough floor space to unroll the spring assemblies and affix the border wire or wires to the assemblies. In some instances, it may be desirable to ship the pocketed spring assembly with one or more rigid border wires affixed to the assembly. That is not possible if the pocketed spring assembly is to be shipped in a rolled up condition. It has therefore been one objective of this invention to provide an efficient, relatively inexpensive method of packaging and shipping pocketed spring assemblies with one or more rigid border rod or rods attached to the assembly.

In the past, unpocketed spring assemblies have been shipped in a flat condition with border rods attached to the unpocketed spring assemblies. In such instances, the unpocketed spring assemblies have been flat-packed by including multiple unpocketed spring cores in an assembled relationship compressed between two pallet-like frames. These end frames generally comprise wooden side boards and multiple slats between the side boards strong enough to withstand expansion forces of the spring assemblies when multiple spring cores and end frames are compressed and wrapped with multiple steel strapping bands. When so wrapped though, the center portion of the wrapped compressed package tends to bow or balloon outwardly which makes stacking of multiple compressed packages difficult and may damage one or more of the unpocketed spring cores. To minimize or eliminate that outwardly ballooning of the center portion of the package containing the unpocketed spring core assemblies, loops of metal straps are generally wrapped about interior slats of the wooden frames on opposed sides of the package and extending through the package of unpocketed spring assemblies so that when the loops of metal straps are pulled taut, the center portions of the wooden frames on opposite sides of the package are pulled inwardly, thereby eliminating the bulging or ballooning effect of the compressed unpocketed spring assembly package.

When pocketed spring core assemblies were attempted to be flat-packed in the same manner as unpocketed spring core assemblies, it was found that the interior metal straps used to eliminate the bulging or bowing of the center portion of the pocketed spring core assemblies, the interior metal straps tended to cut or rip the fabric pocketing material of the pocketed spring assemblies, thereby creating an unsightly, unacceptable product.

It has therefore been an objective of this invention to provide a new method and a new package of pocketed spring core assemblies which enables the pocketed spring assemblies to be compressed and flat-packed to a manufacturer without substantially adversely impacting the fabric material within which the springs of the package are contained, thereby enabling the compressed pocketed spring core assemblies to be flat-packed and shipped, either with or without a surrounding rigid border wires.

It has been another objective of this invention to provide a method of packing pocketed spring core assemblies for shipment in a condition other than being rolled-up.

### SUMMARY OF THE INVENTION

In accordance with the practice of the invention of this application, a stack of pocketed spring core assemblies are placed in a compression machine along with a pair of pallet-like, rigid wooden frames on opposite ends of the stack. The complete stack of pocketed spring core assemblies having the rigid wooden frames on opposite ends of the stack are then compressed within the machine to which the complete package of compressed pocketed spring core assemblies and wooden frames are tightly wrapped with bands of steel strapping material. At least one wire and, preferably, multiple wires, are inserted through the stack of compressed spring core assemblies at spaced locations in the stack, which locations are separated by at least one interior board of the rigid frame on each side of the stack. The ends of each wire are then pulled taut and connected at opposite ends of each wire, thereby pulling the center portions of the opposed frames on each side of the stack inwardly so a to prevent the center portion of the package from ballooning outwardly after removal of compression forces on the frame imparted by the compression machine.

One aspect of this invention is predicated upon the method by which the wire or wires are inserted through the stack of pocketed spring assemblies and through the fabric of those spring assemblies without materially adversely affecting the appearance of the pocketed spring assemblies. According to this aspect of the invention, a threaded rod having a hollow interior is inserted through the stack of pocketed spring assemblies, after which the wire is inserted through the hollow interior of the rod. The rod is then withdrawn from the stack leaving the wire in place extending through the stack.

Another aspect of this invention is predicated upon the method by which the opposite ends of the wire or wires are connected together and pulled taut. According to this aspect of this invention, loops are formed on opposite ends of each wire and interconnected by a loop of steel banding material which extends between the loops on opposite ends of the wire. This loop of banding wire is then pulled taut, thereby pulling taut and tightening the loop of wire extending through the stack of pocketed spring assemblies and around the boards of the wooden frames located on opposite sides of the stack. Additionally, and in a preferred embodiment of the invention, D rings are attached to the loops at the opposite ends of the wire and it is through these D rings that the loop of steel banding or strapping material is inserted before being pulled taught and secured in an overlapping tightened or locked condition.

The method of flat-packing multiple pocketed spring core assemblies, wherein each spring core assembly contains multiple springs encased within fabric pockets, may be characterized as follows: 1) Stacking multiple pocketed spring core assemblies to create a stack of pocketed spring core assemblies; 2) entrapping the stack of spring core assemblies between a pair of frames, each of the frames including a pair of longitudinally extending side elements and at least one other element extending longitudinally parallel to the side elements, and at least one transversely extending cross element connected at its opposite ends to the side elements; 3) compressing the stack of spring core assemblies between the pair of frames; 4) tightly wrapping bands about the compressed stack of spring core assemblies and the frames; 5) inserting a wire through the stack of compressed of spring core assemblies at two spaced locations in the stack, which locations are separated by at least one of the cross elements of the frame on each side of the stack; and 6) pulling opposite ends of the wire taut and connecting opposite ends of the wire on one side of the stack so as to prevent the center portion of the stack from ballooning outwardly after removal of compression forces on the frames.

Another way of characterizing the method of flat-packing multiple pocketed spring core assemblies, wherein each spring core assembly contains multiple springs encased within fabric pockets, is as follows: 1) stacking multiple pocketed spring core assemblies to create a stack of pocketed spring core assemblies; 2) entrapping the stack of spring core assemblies between a pair of wooden frames, each of the frames including a pair of longitudinally extending side boards located on opposite sides of the stack of spring core assemblies as well as at least one other board extending longitudinally parallel to the side boards, and at least one transversely extending cross board connected at its opposite ends to the side boards; 3) compressing the stack of spring core assemblies between the pair of wooden frames; 4) tightly wrapping metal bands about the compressed stack of spring core assemblies and the wooden frames; 5) inserting a metal wire through the stack of compressed of spring core assemblies at two spaced locations in the stack, which locations are separated by at least one of the boards of the frame on each side of the stack; 6) pulling opposite ends of the metal wire taut and connecting opposite ends of the wire on one side of the stack so as to prevent the center portion of the stack from ballooning outwardly after removal of compression forces on the frames.

Another way of characterizing this invention is as follows: A method of preventing the center portion of a flat package containing a plurality of compressed pocketed spring core assemblies entrapped between a pair of frames from ballooning outwardly, which method comprises: inserting a metal wire through a stack of a plurality of compressed pocketed spring core assemblies at two spaced locations in the stack, which locations are separated by at least one element of the frame on each side of the stack; and pulling opposite ends of the metal wire taut and connecting opposite ends of the wire on one side of the stack.

Another way of characterizing this invention is as follows: A method of preventing the center portion of a flat package containing a plurality of compressed pocketed spring core assemblies entrapped between a pair of wooden frames from ballooning outwardly, which method comprises: inserting a metal wire through a stack of the plurality of compressed pocketed spring core assemblies at two spaced locations in the stack, which locations are separated by at least one board of the frame on each side of the stack; and pulling opposite ends of the metal wire taut and connecting opposite ends of the wire on one side of the stack.

The result of the practice of this method of flat-packing multiple pocketed spring core assemblies is a package of flat-packed pocketed spring core assemblies sandwiched between a pair of frames. Each frame includes a pair of longitudinally extending side elements or side boards located on opposite sides of the compressed stack. This complete package, surrounded by a plurality of strapping bands wrapped about the package, includes the compressed pocketed spring core assemblies, the frames and at least one wire extending through the stack of compressed pocketed spring core assemblies at two spaced locations in the stack and wrapped about two of the interior elements of each frame, one frame being on each side of the stack. The opposite ends of this wire are pulled taut and maintained taut and connected together on one side of the stack so as to prevent the center portion of the stack from ballooning forwardly.

The resultant product may be characterized as follows: a package of flat-packed pocketed spring core assemblies, each pocketed spring core assembly of which contains multiple springs encased within fabric pockets, which package contains: a stack of compressed pocketed spring core assemblies entrapped between a pair of frames, each of the frames including a pair of longitudinally extending side elements and at least one transversely extending cross element connected at its opposite ends to the side elements; a plurality of strapping bands wrapped about the compressed stack of pocketed spring core assemblies and the frames; a wire extending through the stack of compressed pocketed spring core assemblies at two spaced locations in the stack, which locations are separated by at least one of the elements of the frame on opposite sides of the stack; and opposite ends of the wire being pulled and maintained taut and connected together on one side of the stack so as to prevent a center portion of the stack from ballooning outwardly.

The resultant product may alternatively be characterized as follows: A package of flat-packed pocketed spring core assemblies, each pocketed spring core assembly of which contains multiple springs encased within fabric pockets, which package contains: a stack of compressed pocketed spring core assemblies entrapped between a pair of wooden frames, each of the frames including a pair of longitudinally extending side boards located on opposite sides of the stack of spring core assemblies as well as at least one other board extending longitudinally parallel to the side boards and at least one transversely extending cross board connected at its opposite ends to the side boards; a plurality of metal strapping bands wrapped about the compressed stack of pocketed spring core assemblies and the frames; a plurality of wires extending through the stack of compressed pocketed spring core assemblies at two spaced locations in the stack, which locations are separated by at least one of the boards of the frame on opposite sides of the stack; and opposite ends of each of the wires being pulled and maintained taut on one side of the stack and connected together so as to prevent a center portion of the stack from ballooning outwardly.

One advantage of this invention is that it enables pocketed spring assemblies to be shipped to a mattress manufacturer in a compressed state and while having rigid border wires attached to the spring assembly. It also has the advantage of enabling the pocketed spring assemblies to be shipped very economically and without any unsightly damage to the fabric of the pocketed spring assemblies.

These and other objects and advantages of this invention will be more apparent from the following description of the drawings.

### BRIEF DESCRIPTION OF THE DRAWINGS

FIG. 1 is an exploded perspective view of stack of pocketed spring assemblies and wooden frames to be contained in a package of pocketed spring assemblies in accordance with the practice of this invention;

FIG. 2 is a side elevational view of the stack of pocketed spring assemblies and wooden end frames pressed between a pair of press posts of a mattress core compression machine, the press posts of the press being in an open condition illustrated in phantom, and being shown in a closed compressed condition in solid lines along with the stack of pocketed spring assemblies and wooden end frames;

FIG. 3 is a side elevational view of the stack of compressed pocketed spring assemblies and wooden frames of FIG. 2 illustrating insertion of a hollow threaded rod through the compressed stack;

FIG. 4 is an enlarged side elevational view of the hollow threaded rod of FIG. 3;

FIG. 5 is a view similar to FIG. 3 illustrating how a wire is inserted through a pair of hollow threaded rods and through the stack of compressed pocketed spring assemblies;

FIG. 6 is a view similar to FIG. 5, but illustrating the wire as having been inserted completely through the stack of pocketed spring assemblies and wooden frames;

FIG. 7 is an enlarged end elevational view of a portion of the stack of compressed pocketed spring assemblies and wooden frames illustrating how the opposite ends of the wires are pulled taut and interconnected to form a loop of wire extending through the stack of pocketed springs at two spaced locations and about two spaced slats on each side of the stack so as to prevent the center portion of the package from ballooning outwardly upon removal of the compression forces imparted by the compression machine;

FIG. 8 is an enlarged perspective view illustrating the manner in which a D ring is attached to an opposite end of the loop of wire extending through the package;

FIG. 9A is an end elevational view of one side of the assembled package of compressed pocketed spring assemblies and wooden frames; and

FIG. 9B is an end elevational view of the opposite side of the package of pocketed springs and wooden frame from the view illustrated in FIG. 9A.

### DETAILED DESCRIPTION OF THE DRAWINGS

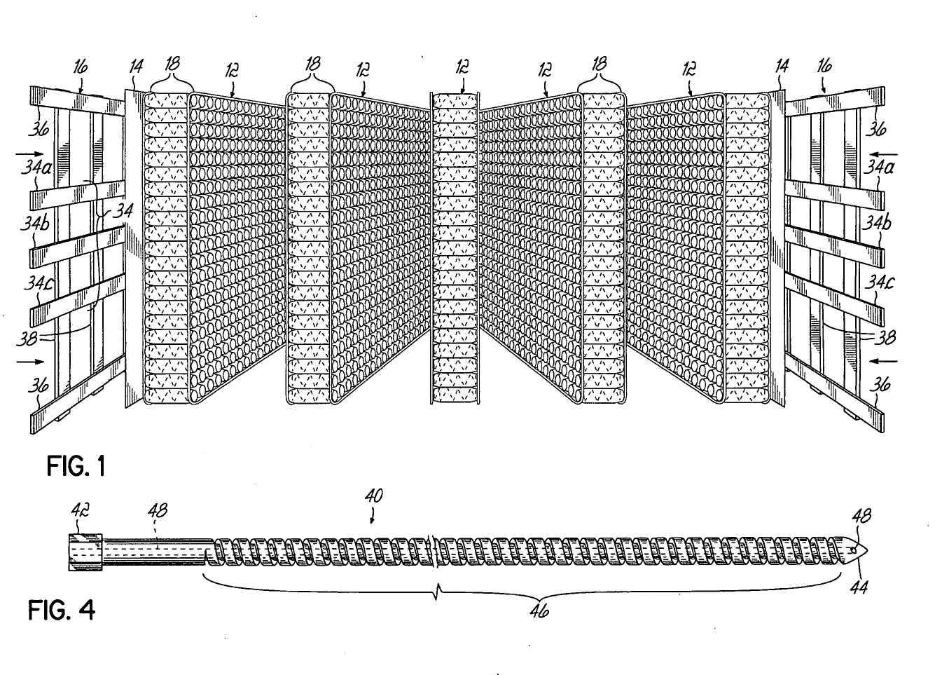

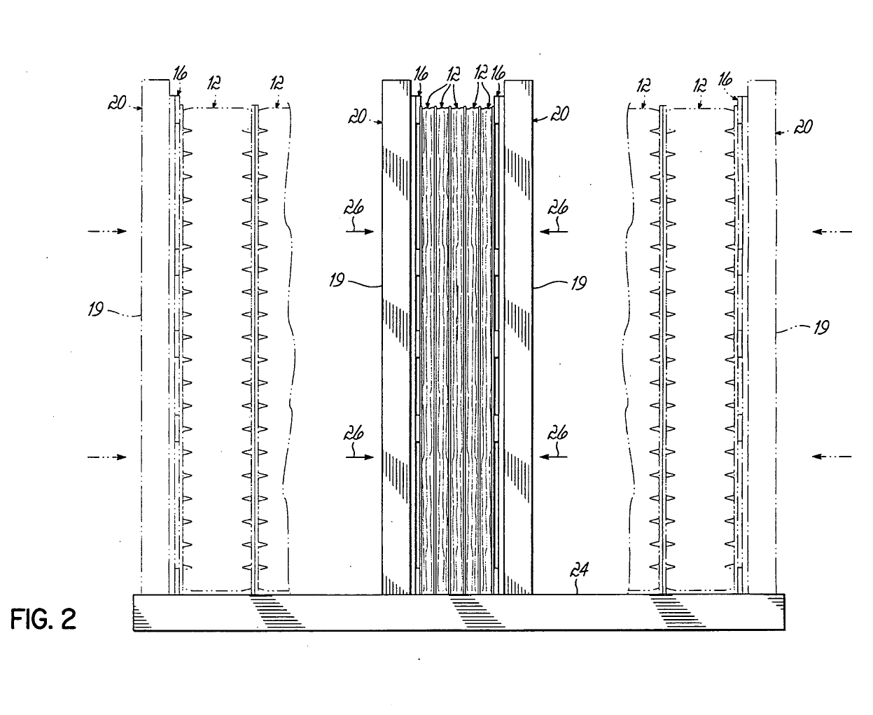

With reference first to FIG. 1, there is illustrated the components used to create the multiple pocketed spring core assembly package 10 of this invention. These components include a plurality or stack of pocketed spring core assemblies 12, end sheets of protective craft paper or cardboard sheeting 14 placed on opposite sides of the stack of pocketed spring core assemblies 12, and rigid frames 16, preferably wooden frames, located on opposite ends of the package. As explained more fully hereinafter, those components are, in accordance with the practice of the method of this invention, placed into a conventional mattress spring core press machine 20 as a first step in the creation of the compressed pocketed spring core package 10 of this invention. See FIG. 2.

The pocketed spring core assemblies 12 are conventional and well known in the mattress trade. These assemblies form the inner part of many commercially manufactured mattresses. Each pocketed spring core assembly 12 comprises multiple rows and columns of springs encased in fabric pockets, assembled into an array of assembled pocketed springs adhered or otherwise secured together to create a self-sustaining array of pocketed springs. One or more border wires 20 may surround the pocketed spring core assembly 12 and be affixed to the pocketed spring core assembly 12 in any one of numerous ways. One patent which illustrates such an array of pocketed springs is illustrated and described, for example, in U.S. Pat. No. 6,813,791. Although each pocketed spring assembly 12 is illustrated with a pair of border wires 18, the present invention does not require the use of rigid border wires extending around the periphery of each mattress spring core assembly 12. The present invention may be used to package any type of pocketed spring core with or without border wires. The border wires 18 may be attached to the pocketed spring core assembly 12 by conventional connectors as, for example, hog rings extending through the fabric of the outermost pockets and a portion of an end turn of a spring as well as the border wire. These connections are conventional and well known in the mattress trade.

While there are five pocketed spring core assemblies illustrated in drawings, in practice, such packages or bundles of pocketed spring core assemblies usually include anywhere from 10 to 20 pocketed spring core assemblies or units. Of course, any number of pocketed spring assemblies or units may be incorporated in the package.

In order to compress the bundle or stack of a plurality of on-edge pocketed spring core assemblies 12, end sheets of protective paper or cardboard 14, and the rigid frames 16, such components are placed into the conventional mattress press compression machine 20. The compression machine 20 comprises at least one pair of vertically extending posts 19 mounted upon a horizontally movable slide (not shown) which is in turn contained within a base 24 of the machine, as illustrated by the arrows 26 in FIG. 2. There are two slides, each containing a pair of spaced, vertical posts 19 movable toward one another from a position illustrated in phantom to a position illustrated in a solid line in FIG. 2 so as to compress the combination of pocketed spring core assemblies 12. At each end of the combination, protective craft paper or cardboard 14 and an end frame 16 are placed between an endmost or outer most pocketed spring assembly 12 and the movable posts 19 of the press 20. While the posts 19 of the press 20 on both ends of the machine 20 have been illustrated by the arrows 26 as being horizontally movable, one set of posts 19 may be stationary and the other set of posts 19 movable toward the stationary posts so as to create the pressed assemblage of components.

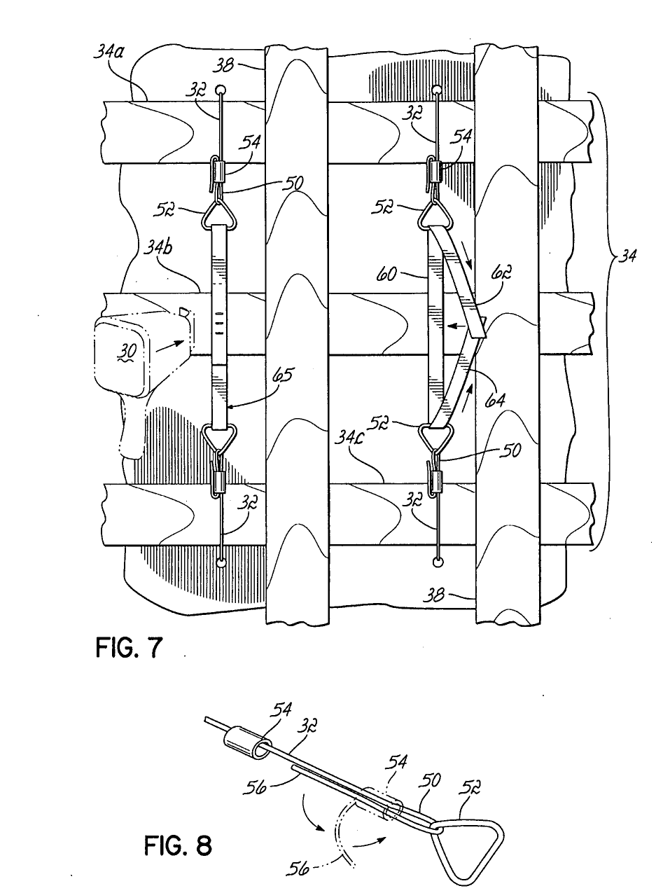

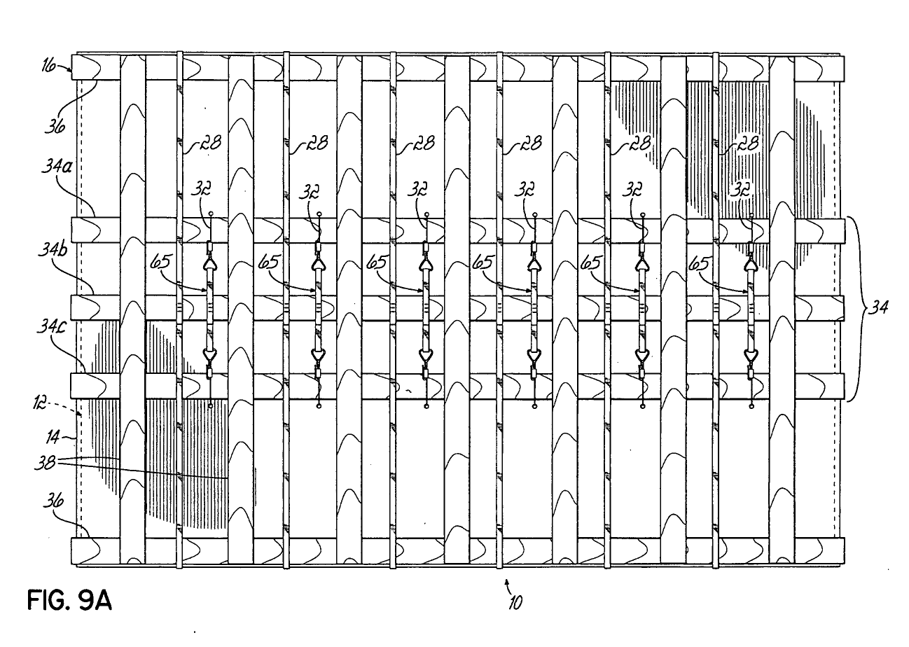

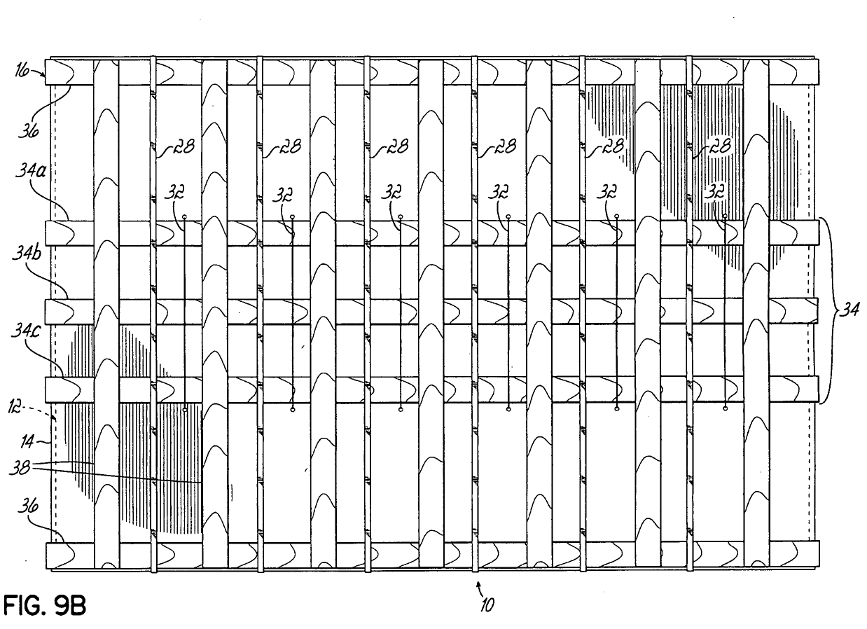

After completion of the compression of the assemblage, the compressed package is wrapped in bands of steel strapping material 28 as shown in FIGS. 9A and 9B. After wrapping of the complete package 10 with bands of steel strapping 28 around the package 10, the interior of the package is further compressed in a manner described below. A conventional banding gun 30 (see FIG. 7) is used to pull each band 28 taut, then pinch together and lock the overlapped ends of the bands to cinch them in a locked condition. Such a banding gun 30 is well known in the trade and has not been illustrated or described in detail. One such banding gun, which has been found to be suitable for this application, is identified as a Fromm ⅝″ A25A5-5 pneumatic seallous banding gun. Of course, any conventional steel strapping or banding gun may be utilized in the practice of this invention.

With reference to FIGS. 9A and 9B, it will be seen that there are six steel bands 28 wrapped about the complete packaged assembly of pocketed spring cores 12, protective covering material 14, and wooden frames 16. Of course, this number may vary, depending upon the size and number of mattress cores being packaged. If desired, the protective covering material 14 may be omitted. Alternatively, additional protective covering material 14 may be included in the package, such as between adjacent pocketed spring core assemblies 12.

In order to eliminate ballooning or outward bulging of the center portion of the package, and in accordance with the practice of this invention, loops of high tensile strength wire 32, each wire having a round cross-sectional configuration, are wrapped about spaced frame elements 34, more particularly about boards 34a, 34b and 34c of the frame 16 on each side of the packaged assembly. As explained more fully hereinafter, the ends of these loops of wire 32 are then interconnected after having been pulled taut as to minimize or eliminate this ballooning effect at the center portion of the assemblage. The wire 32 is preferably 13 gauge wire but may be any desired gauge.

With reference now to FIGS. 1, 9A and 9B, it will be seen that each wooden frame 16 comprises a pair of horizontally oriented longitudinally extending side elements or boards 36 which extend for the length of the pocketed spring core assemblies 12 at the top and bottom of those assemblies. Additionally, three longitudinally extending center elements or boards 34a, 34b and 34c extend parallel to top and bottom side elements 36. Additionally, vertically oriented transverse elements or boards 38 extend between the longitudinally extending side elements 36 and are fixedly attached thereto. These vertically extending transverse elements 38 are also fixedly attached to the longitudinally extending elements or boards 34a, 34b and 34c. Although one configuration of rigid frame 16 is illustrated and described, any other type or configuration of rigid frame made of any desired material may be used.

Although the drawings show the pocketed spring core assemblies 12 oriented or stacked on their sides, they may oriented so that they lay on their end surfaces rather than their side surfaces. In such an orientation, the longitudinal dimension of the pocketed spring core assembly 12 would be vertically oriented and the transverse dimension of the pocketed spring core assembly 12 would be horizontally oriented. The frames 16 would then be rotated approximately ninety degrees from their illustrated orientation.

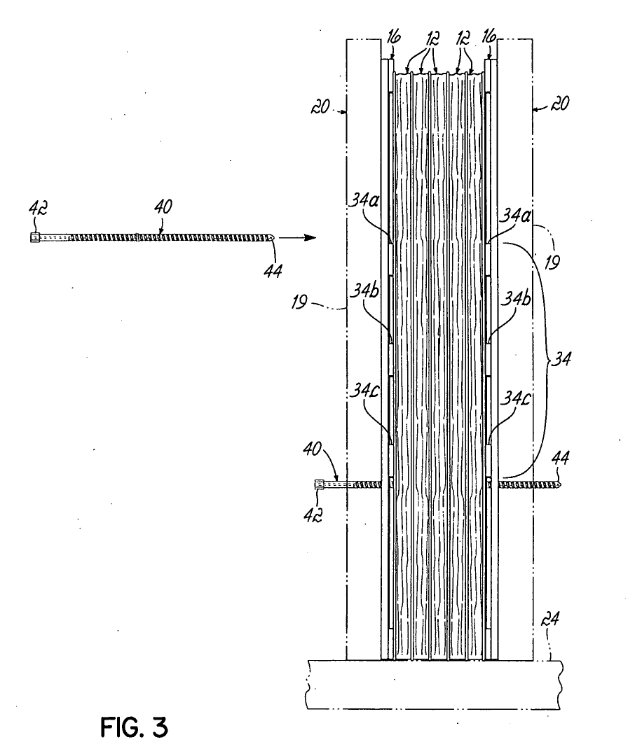

In order to enable the loop of wire 32 to be inserted through the compressed package of pocketed spring assemblies, and as illustrated in FIG. 3, a hollow threaded rod 40 is first passed through the assembled package of pressed pocketed spring core assemblies 12, layers of protective covering material 14 and frames 16. See FIG. 3. This occurs while the assemblage is still retained in a compressed condition within the compression machine or press 20. As shown in FIG. 3, one of the hollow threaded rods 40 is passed through the assemblage above longitudinally extending boards 34a of opposed frames 16 and another hollow threaded rod 40 is passed through the assemblage below opposed longitudinally extending boards 34c of opposite frames 16 on opposite sides of the package.

With reference to FIG. 4, it will be seen that each hollow threaded rod 40 comprises a hexagonal-shaped end 42 at one end of the rod and a pointed end 44 at the other end of the rod. Intermediate of these ends, there is a helically threaded section 46 which extends from the pointed end 44 of the rod very nearly to the opposite hexagonally-shaped end 42 at the opposite end of the rod. Between the ends of the rod 40, there is a central axial bore (indicated by dashed lines in FIG. 4) which extends for the full length of the rod. Preferably, this rod is made of steel and is approximately 0.3125 inches in diameter with the central axial bore 48 being sized so as to accommodate relatively heavy gauge high tensile strength steel wire 32.

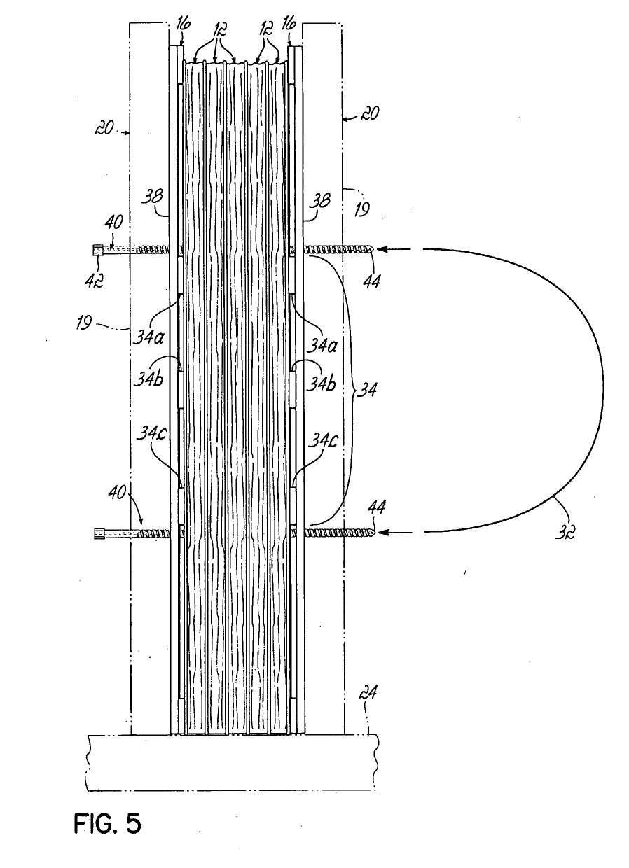

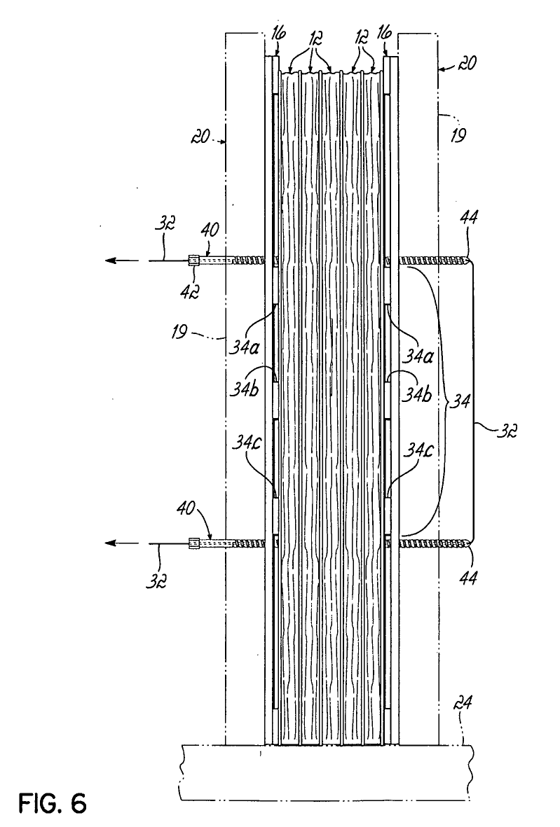

In order to enable the wire 32 to be inserted through the compressed package of pocketed coil spring assemblies, the hollow threaded rod 40 is first rotatably driven through the compressed package of pocketed coil springs. The rod 40, because of its threading, when rotated and pressed against the pocketed spring assemblage, self-threads through the assemblage of pocketed spring materials and springs to and through the opposite side of the assemblage. After two of such hollow rods 40 have been threaded through the assemblage, one above slats 34a and one below slats 34c, respectively, on both sides of the assemblage, a wire 32 is inserted through the central axial bore 48 of the rods 40. See FIGS. 3, 5 and 6. Thereafter, each rod 40 is rotated in the opposite direction to remove it from the assemblage. During this removal of the rod 40, the wire 32 remains extending through the compressed assemblage as illustrated in FIGS. 5 and 6 with both ends of the wire 32 located on one side of the assemblage. Thereafter, a loop 50 is formed on both ends of the wire as illustrated in FIGS. 7 and 8. Preferably, a D ring 52 is contained within this loop 50 at each end of the wire 32. A tube sleeve 54 is then placed over the doubled over ends of the loop 50 and squeezed so as to secure the loop 50, after which the ends 56 at each end of the wire 32 are bent outwardly (as shown in phantom in FIG. 8) so as to prevent the loop 50 from becoming undone.

Thereafter, and as best illustrated in FIG. 7, a piece or length of steel banding material 60 is inserted between the D rings on each end of the loop of wire 32. The ends 62, 64 of this length of banding material 60 are then overlapped, after which a steel banding gun 30 is placed over the overlapped ends 62, 64 of the length of steel banding material 60 and the banding gun 30 actuated so as to pull the length of steel banding material 60 taut. After the length of banding material 60 has been pulled taut, the overlapped ends 62, 64 of the length of banding material 60 are cinched together so as to create a loop of banding material 65 maintained in a taut or connected condition.

As illustrated in FIGS. 9A and 9B, six loops of wire 32 are passed around longitudinally extending boards 34a, 34c on both sides of the assembled package of pocketed spring assemblies 12 and rigid frames 16 and pulled taut so as to prevent the center portion of the package 10 from ballooning outwardly when the pressure of the machine or press 20 is removed from the package. Of course, a greater or lesser number of such loops of wire 32 may be utilized in the practice of this invention. After placement of the loops around the boards 34a, 34c on both sides of the wooden frames 16 and after pulling each of these loops together and interconnecting them in a taut condition, the assemblage may be removed from the press by opening of the pressure-applying posts of the machine, after which the complete assemblage may be removed for shipment to a mattress manufacturer.

While the loops of wire 32 have been demonstrated in one preferred embodiment of the invention as extending between and being wrapped around two longitudinally extending boards of the wooden frames 16, those loops of wire could, as well, be wrapped around two spaced transversely extending boards 38 on both sides of the assembled package with the same result of preventing ballooning of the center portion of the package upon removal of the packaged assembly from the machine or press 20. Additionally, the frames 16 could be made from a material other than wooden boards as, for example, a composite material or returnable metal frames.

While we have described only a single embodiment of our invention, we do not intend to be limited except by the scope of the following appended claims.

We claim:

1. A package of flat-packed pocketed spring core assemblies, each: pocketed spring core assembly of which contains multiple springs encased within fabric pockets, which package contains:
a stack of compressed pocketed spring core assemblies entrapped between a pair of frames, each of the frames including a pair of longitudinally extending side elements and at least one transversely extending cross element connected at its opposite ends to the side elements;
a plurality of strapping bands wrapped about the compressed stack of pocketed spring core assemblies and the frames;
a wire extending through the stack of compressed pocketed spring core assemblies at two spaced locations in the stack, which locations are separated by at least one of the elements of the frame on opposite sides of the stack; and
opposite ends of the wire being pulled and maintained taut and connected together on one side of the stack so as to prevent a center portion of the stack from ballooning outwardly.

2. A package of flat-packed pocketed spring core assemblies, each pocketed spring core assembly of which contains multiple springs encased within fabric pockets, which package contains:
a stack of compressed pocketed spring core assemblies entrapped between a pair of wooden frames, each of the frames including a pair of longitudinally extending side boards located on opposite sides of the stack of pocketed spring core assemblies as well as at least one other board extending longitudinally parallel to the side boards and at least one transversely extending cross board connected at its opposite ends to the side boards;
a plurality of metal strapping bands wrapped about the compressed stack of pocketed spring core assemblies and the frames;
a plurality of wires extending through the stack of compressed pocketed spring core assemblies at two spaced locations in the stack, which locations are separated by at least one of the boards of the frame on opposite sides of the stack; and
opposite ends of each of the wires being pulled and maintained taut on one side of the stack and connected together so as to prevent a center portion of the stack from ballooning outwardly.
